(19) United States
(12) Patent Application Publication
(10) Pub. No.: US 2025/0300176 A1
(43) Pub. Date: Sep. 25, 2025

(54) LITHIUM NICKEL PHOSPHATE TERNARY GLASSES, METHOD TO OBTAIN THEM AND THEIR USES

(71) Applicant: COMMISSARIAT A L'ENERGIE ATOMIQUE ET AUX ENERGIES ALTERNATIVES, Paris (FR)

(72) Inventors: Taos GUYOT, Grenoble (FR); Julia AGULLO, Grenoble (FR); Alexi CARDOSO, Grenoble (FR); Alexis DELANOË, Grenoble (FR); Sébastien MARTINET, Grenoble (FR); Damien PERRET, Grenoble (FR); Loïc SIMONIN, Grenoble (FR)

(73) Assignee: COMMISSARIAT A L'ENERGIE ATOMIQUE ET AUX ENERGIES ALTERNATIVES, Paris (FR)

(21) Appl. No.: 19/083,806

(22) Filed: Mar. 19, 2025

(30) Foreign Application Priority Data
Mar. 20, 2024 (FR) 2402781

(51) Int. Cl. H01M 4/58; C03C 3/23; C03C 4/14; C03C 12/00; H01M 4/02; H01M 4/04; H01M 4/1397; H01M 4/62

(52) U.S. Cl. CPC H01M 4/5825; C03C 3/23; C03C 4/14; C03C 12/00; H01M 4/0404; H01M 4/1397; H01M 4/625; C03C 2204/00; H01M 2004/021; H01M 2004/028; H01M 2220/20

(57) ABSTRACT

The present disclosure relates to lithium nickel phosphate ternary glasses and to the method to obtain them. The disclosure also relates to the preparation and use of lithium nickel phosphate ternary glasses as active materials of positive electrodes, in particular of metal-ion accumulators, as well as the active materials and electrodes.

### CROSS-REFERENCE TO RELATED APPLICATION

This application claims priority to FR 2402781, filed Mar. 20, 2024, the disclosure of which is hereby expressly incorporated by reference herein in its entirety.

### TECHNICAL FIELD

The present disclosure relates to lithium nickel phosphate ternary glasses and to the method to obtain them. The disclosure also relates to the preparation and the use of said glasses as active materials of positive electrodes, in particular of metal-ion accumulators, as well as said active materials and electrodes per se.

### BACKGROUND

LiCoO₂(LCO) is the positive electrode technology used in the first lithium-ion accumulator marketed by Sony in 1991. This technology has a very high energy density and is relatively easy to use. However, the instability associated with the use of cobalt dioxide (CoO₂) makes this technology unsafe from an industrial point of view, and speculation in cobalt prices is driving up its price.

Among the other different well-established Li-ion battery pack positive electrode technologies, LiFePO₄ (LFP) is a technology known for its very good power and cycling characteristics, while having the great advantage of high intrinsic safety and very good calendar and cycling life.

However, the theoretical capacity of LiFePO₄ (170 mAh/g) combined with an average operating voltage of 3.2 V is an obstacle to its application in battery packs requiring high energy densities. This constraint is illustrated by the limited range of electric vehicles (less than 160 km) equipped with this technology, which limits their widespread introduction.

To increase energy densities, it is generally necessary to develop new cathode materials beyond LFPs and LCOs, which use more than one Li per 100 atomic mass units.

To increase energy densities, it is generally necessary to develop new cathode materials beyond LFP and LCO that are capable of exchanging more than one Li per transition metal.

The development of glass-based positive electrodes is an interesting approach, in particular because the glasses synthesis method is easier to implement than for other synthesis methods (such as hydrothermal synthesis, for example). It is also easily scalable for large-scale material synthesis. In addition to this, the glassy network forming the structure of glasses is less rigid and consists of a larger fraction of free volume (vacant space) than their crystallized counterparts. Theoretically, this would thus allow glasses to incorporate and extract alkali ions more easily, as well as accepting more readily the structural modifications that can occur during cycling. Due to the many accessible oxidation states of vanadium, vanadate-based glass electrodes have been considered as interesting alternatives. Currently in the literature, the best electrochemical performance for a vanadium-based glass is achieved by a material based on the Li₂O—B₂O₃—V₂O₅ system, which achieves 1000 Wh/kg at the scale of the active material over 10 cycles.

However, this material is still limited by a fairly low operating potential (2.4 V vs Li⁺/Li) and above all by its extremely low first charge (20 mAh/g).

In addition, vanadium poses toxicity and cost issues that limit its long-term application in particular in the electric mobility and stationary storage sectors.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In an aspect, the present disclosure relates to a glass of the following formula (I):

$$x Li 2 O \cdot y NiO \cdot ( 100 - x - y ) P 2 O 5 , \qquad ( I )$$

wherein:

0<x<100,

$$10 \leq y < 100 ,$$

$$and$$

$$40 < x + y < 100 .$$

### DESCRIPTION OF THE DRAWINGS

The foregoing aspects and many of the attendant advantages of this disclosure will become more readily appreciated as the same become better understood by reference to the following detailed description, when taken in conjunction with the accompanying drawings, wherein:

FIG. 1 shows a thermal production cycle for glass 31 Li₂O·15 NiO·54 P₂O₅, according to example 1.

FIG. 2 shows the galvanostatic cycling curves between 1.5 V vs Li/Li⁺ and 4.5 V vs Li/Li⁺ for glass of composition 31 Li₂O·15 NiO·54 P₂O₅ with a load start at C/100. The first three cycles have been represented. The theoretical specific capacity based on the change in valency Ni²⁺⇄Ni⁴⁺(i.e. the exchange of 2 electrons) is equivalent to 85 mAh/g.

FIG. 3 shows the galvanostatic cycling curves between 1.5 V vs Li/Li⁺ and 4.5 V vs Li/Li⁺ for glass of composition 14 Li₂O·28 NiO·58 P₂O₅ with a load start at C/100. The first three cycles have been represented. The theoretical specific capacity based on the change in valency Ni²⁺⇄Ni⁴⁺(i.e. the exchange of 2 electrons) is equivalent to 140 mAh/g.

FIG. 4 shows the galvanostatic cycling curves between 1.5 V vs Li/Lit and 4.5 V vs Li/Li⁺ for glass of composition 21.5 Li₂O·21.5 NiO·57 P₂O₅ with a load start at C/100. The first three cycles have been represented. The theoretical specific capacity based on the change in valency Ni²⁺⇄Ni⁴⁺(i.e. the exchange of 2 electrons) is equivalent to 112 mAh/g.

### DETAILED DESCRIPTION

The detailed description set forth below in connection with the appended drawings, where like numerals reference like elements, is intended as a description of various embodiments of the disclosed subject matter and is not intended to represent the only embodiments. Embodiments described in this disclosure are provided merely as examples or illustrations and should not necessarily be construed as preferred or advantageous over other embodiments. The illustrative examples provided herein are not intended to be exhaustive or to limit the claimed subject matter to the precise forms disclosed.

There is a need to provide compounds that do not have the above-mentioned disadvantages. The present disclosure addresses these and other long-felt and unmet needs in the art.

In particular, one objective of the present disclosure is to provide compounds capable of being used successfully for the preparation of positive electrodes, in particular metal-ion accumulators (the metal being in particular an alkali or alkaline-earth metal, for example Li, Na, K, Mg or Ca), having high capacities and/or high energy densities, in particular higher than those relating to devices of the prior art, while avoiding metals which are critical from an economic and/or toxic point of view, such as cobalt or vanadium.

Embodiments of present disclosure also relate to a glass of the following formula (I):

$$x {Li}_{2} O \cdot y NiO \cdot ( 100 - x - y ) {P}_{2} {O}_{5} , \qquad ( I )$$

with:

0<x<100,

$$10 \leq y < 100 ,$$

$$and$$

$$40 < x + y < 100 .$$

“Glass” refers in particular to a solid amorphous or substantially amorphous metastable compound.

“Amorphous” refers in particular to a solid compound with no medium or long range ordered atomic structure.

“Substantially amorphous” means in particular that the compound is more than 97%, in particular more than 98 or 99% amorphous by mass.

The amorphous nature can be determined by any technique well known to the person skilled in the art, in particular by X-ray diffraction (XRD).

According to a particular embodiment, 41<x+y<100, with in particular 42, 43, 44 or 45<x+y<100.

According to a particular embodiment, the present disclosure relates to a glass such that 1≤x/y<4.

According to a particular embodiment, x<95, or even 90, 80, 70 or 60.

According to a particular embodiment, y<95, or even 90, 80, 70 or 60.

According to a particular embodiment, x<95 or even 90, 80, 70 or 60 and y<95 or 90, 80, 70 or 60.

According to a particular embodiment, 0.5<x/y<2.5 or 3.0 or 4.0.

Embodiments of the present disclosure relate to a glass as defined above, the formula of which is chosen from the following formulae:

31 Li₂O·15 NiO·54 P₂O₅;

14 Li₂O·28 NiO·58 P₂O₅;

21.5 Li₂O·21.5 NiO·57 P₂O₅.

For any given particular formula (I) or (I₀), each value of x and of y is to within +0.5%, or even within +1% or +2%. As such, and for example, an x or y value of 55+1% comprises the values 54.45 to 55.55.

According to another aspect, the present disclosure also relates to a method for preparing a glass as defined above, comprising a step (i) of quenching a molten mixture (A), which consists of or comprises a source of NiO, the source of Li₂O and a source of P₂O₅, to obtain said glass. Some of, or all of, the embodiments described above in relation to the glass of the present disclosure also apply here, alone or in combination.

According to another aspect, the present disclosure also relates to a method for preparing a glass of the following formula (I₀):

$$x {Li}_{2} O \cdot y NiO \cdot ( 100 - x - y ) {P}_{2} {O}_{5} , \qquad ( {I}_{0} )$$

with:

0<x<100,

$$10 \leq y < 100 ,$$

$$and$$

$$x + y < 100 .$$

The method comprising a step (i) of quenching a molten mixture (A), which consists of or comprises a source of NiO, the source of Li₂O and a source of P₂O₅, to obtain said glass.

Some of, or all of, the embodiments described above in relation to the glass of the present disclosure also apply here, alone or in combination.

According to a particular embodiment, x<95, or even 90, 80, 70 or 60.

According to a particular embodiment, y<95, or even 90, 80, 70 or 60.

According to a particular embodiment, x<95 or 90, 80, 70 or 60 and y<95 or 90, 80, 70 or 60.

According to a particular embodiment, quenching can be carried out by casting onto a plate, for example a metal plate, or can be accelerated by the application of mechanical stress, for example by hammering.

According to a particular embodiment, the method as defined above comprises:
a step (i) of quenching a molten mixture (A), which consists of or comprises a source of NiO, the source of Li₂O and a source of P₂O₅, to obtain an intermediate glass;
a step (ii) of crushing the intermediate glass obtained at the end of step (i);
a step (iii) of quenching the crushed intermediate glass obtained at the end of step (ii), previously in a molten state, to obtain the glass as defined above.

According to a particular embodiment, the molten mixture of step (i) as described above, and/or of step (iii) as described above, is, prior to quenching, at a temperature Tb of between 1000° C. and 1400° C., for example about 1200° C.

“Quenching” refers in particular to a transition from the temperature Tb to a lower temperature, in particular the ambient temperature, at a rate greater than or equal to about 1000° C./min for a plate-cast quench and greater than or equal to about 10000° C./min for a hammer-type quench.

According to a particular embodiment, step (i) as described above is preceded by a step in which the temperature of the mixture of precursor powders is raised to the temperature Ta, followed by a second temperature rise to the temperature Tb. The temperature Tais 800° C. with a temperature rise ranging from 10° C./h to 60° C./h. The temperature rise to Tb is carried out at a heating rate of 60° C./h to 120° C./h.

According to a particular embodiment, the molten mixture of step (iii) as described above is obtained by introducing the crushed intermediate glass of step (ii), as described above, directly at a temperature Tb of between 1000° C. and 1400° C., for example about 1200° C.

According to a particular embodiment, the method according to the present disclosure, as defined above, comprises:

A step (i₀) of raising the temperature of a mixture of precursors (A) consisting of a source of NiO, a source of Li₂O and a source of P₂O₅. This mixture is brought to temperature Ta, followed by a second temperature rise to Tb. The temperature Ta is 800° C. with a temperature rise ranging from 10° C./h to 60° C./h. The temperature rise to Tb is carried out at a heating rate of 60° C./h to 120° C./h.

a step (i) of quenching the molten mixture (A) to obtain said glass.

According to a particular embodiment, the method according to the present disclosure, as defined above, comprises:
A step (i₀) of raising the temperature of a mixture of precursors (A) consisting of a source of NiO, a source of Li₂O and a source of P₂O₅. This mixture is brought to temperature Ta, followed by a second temperature rise to Tb. The temperature Ta is 800° C. with a temperature rise ranging from 10° C./h to 60° C./h. The temperature rise to Tb takes place at a heating rate of 60° C./h to 120° C./h;
a step (i) of quenching a molten mixture (A), which consists of or comprises a source of NiO, the source of Li₂O and a source of P₂O₅, to obtain an intermediate glass;
a step (ii) of crushing the intermediate glass obtained at the end of step (i);
a step (iii₀) of introducing the crushed intermediate glass at a temperature Tb, the temperature Tb being between 1000° C. and 1400° C., for example about 1200° C.;
a step (iii) of quenching the intermediate molten crushed glass obtained at the end of step (iii₀), to obtain the glass as defined above.

According to a particular embodiment, the method according to the present disclosure, as defined above, comprises:

A step (i₀) of raising the temperature, with agitation, of a mixture of precursors (A) consisting of a source of NiO, a source of Li₂O and a source of P₂O₅. This mixture is brought to temperature, followed by a second temperature rise to Tb. The temperature Ta is 800° C. with a temperature rise ranging from 10° C./h to 60° C./h. The temperature is raised to Tb temperature at a heating rate of 60° C./h to 120° C./h.

a step (i) of quenching the molten mixture (A) to obtain said glass.

According to a particular embodiment, the agitation during step (i₀) is a mechanical agitation, in particular by a blade agitator.

According to a particular embodiment, the source of NiO comprises or consists of NiO, Ni₂O₃, and/or NiSO₄.

According to a particular embodiment, the source of P₂O₅ comprises or consists of NH₄H₂PO₄, P₂O₅, (NaPO₃)₆, H₃PO₄, and/or (NH₄)₂HPO₄.

According to a particular embodiment, the source of Li₂O comprises or consists of Li₂CO₃, Li₂SO₄, and/or LiOH.

According to another aspect, the present disclosure also relates to a glass that can be obtained according to one of the methods defined above.

According to another aspect, the present disclosure also relates to a powder consisting of or comprising glass particles as defined above.

According to a particular embodiment, the particles have a size of between 0.1 and 100 μm, in particular between 0.1 and 50 μm, in particular between 1 and 50 μm.

According to a more specific embodiment, the particles have a size of between 0.1 and 5 or even 2 μm.

All the embodiments described above in relation to the glass of the present disclosure also apply here, alone or in combination.

According to another aspect, the present disclosure also relates to a powder consisting of or comprising glass particles of the following formula (I₀):

$$x L {i}_{2} O \cdot y N i O \cdot ( 100 - x - y ) {P}_{2} {O}_{5} , \qquad ( {I}_{0} )$$

with:

0<x<100,

$$10 \leq y < 100 , and$$

$$x + y < 100 .$$

Some or, or all of, the embodiments described above in relation to the glass of the present disclosure also apply here, alone or in combination.

According to a particular embodiment, the powder as defined above is KBr-free.

According to a particular embodiment, the particles have a size of 0.1 to 100 μm, in particular 50 to 100 μm, or 0.1 to 50 μm, in particular 1 to 50 μm.

According to a more specific embodiment, the particles have a size between 0.1 and 5 or even 2 μm.

“Size” refers in particular to the largest dimension of a particle.

This size is in particular an average size determined by laser granulometry.

According to another aspect, the present disclosure also relates to a powder consisting of or comprising particles of glass as defined above and an electronically conductive additive.

In one or more embodiments, the electronically conductive additive, well known to the person skilled in the art, may consist of or comprise hard carbon and/or graphite.

According to another aspect, the present disclosure also relates to a powder consisting of or comprising particles of glass as defined above and carbon particles.

Some or, or all of, the embodiments described above in relation to the glass and/or glass particles of the present disclosure also apply here, alone or in combination.

According to a particular embodiment, the particles have a size of between 0.1 and 100 μm, in particular from 0.1 to 50 μm, in particular from 1 to 50 μm.

According to a more specific embodiment, the particles have a size of between 0.1 and 5 μm.

“Carbon particles” refers to particles that make up black carbon.

“Black carbon” refers in particular to a pulverulent composition of carbon in amorphous form, which is in particular in the form of a powder consisting of or comprising spherical or spheroid particles of 5 to 500 nm (largest dimension), in particular less than 100 nm.

According to another aspect, the present disclosure also relates to a powder consisting of or comprising glass particles and an electronically conductive additive, in particular carbon particles, the glass being of the following formula (I₀):

$$x L {i}_{2} O \cdot y N i O \cdot ( 100 - x - y ) {P}_{2} {O}_{5} , \qquad ( {I}_{0} )$$

with:

0<x<100,

$$10 \leq y < 100 , and$$

$$x + y < 100 .$$

Some of, or all of, the embodiments described above in relation to the glass and/or glass particles of the present disclosure also apply here, alone or in combination.

According to a particular embodiment, the glass particles are mixed with an electronically conductive additive, in particular carbon particles, to form a composite material. In this composite, the particles of additive, in particular of carbon, are distributed in such a way that they envelop the glass particles.

According to a particular embodiment, the ratio of the mass of glass particles to the mass of electronically conductive additive, in particular carbon particles, is between 90/5 or 80/10 and 50/40, this ratio being, for example, 70/25.

According to another particular embodiment, the ratio of the mass of glass particles to the mass of electronically conductive additive, in particular carbon particles, is between 96/2 and 90/5.

According to another aspect, the present disclosure also relates to a powder consisting of or comprising glass particles as defined above, an electronically conductive additive, in particular carbon particles, and a binder.

All the embodiments described above in relation to the glass and/or glass particles of the present disclosure also apply here, alone or in combination.

According to another aspect, the present disclosure also relates to a powder consisting of or comprising glass particles, an electronically conductive additive, in particular carbon particles, and a binder, the glass being of the following formula (I₀):

$$x L {i}_{2} O \cdot y N i O \cdot ( 100 - x - y ) {P}_{2} {O}_{5} , \qquad ( {I}_{0} )$$

with:

0<x<100,

$$10 \leq y < 100 , and$$

$$x + y < 100 .$$

Some or, or all of, the embodiments described above in relation to the glass and/or glass particles of the present disclosure also apply here, alone or in combination.

According to a particular embodiment, the binder is a polymer, in particular chosen from polyvinylidene fluoride (PVDF).

According to a particular embodiment, the powder as defined above comprises, by mass:
from 50 to 80% of glass particles as defined above, in particular 70%;
from 10 to 40% of carbon particles, in particular 25%; and
5 to 10% binder, in particular 5%.

According to a particular embodiment, the powder as defined above comprises, by mass:
90 to 96% glass particles as defined above;
from 2 to 6% of carbon particles, in particular; and
2 to 4% binder.

According to another aspect, the present disclosure also relates to a method for preparing a powder as defined above, comprising a step a) of grinding a glass as defined above.

All the embodiments previously described in relation to glass and/or glass particles, and/or a powder of the present disclosure also apply here, alone or in combination.

According to a particular embodiment, the method of the present disclosure as defined above comprises:
a first stage of grinding, in particular with balls, a glass as defined above, in order to obtain a first glass powder;
a second step of grinding, in particular with balls, a composition comprising the glass powder obtained from the previous step and an electronically conductive additive powder, in particular carbon.

According to a more specific embodiment, the particles of the first glass powder have a size of between 5 and 10 to 20 μm.

Grinding according to step a) as described above can be carried out using a vibratory mill, in particular a dry method, or an attritor (erosion grinding). In the case of a vibratory mill, the glass is typically placed in a mill tank containing one or more grinding balls. By oscillating the grinding vessel horizontally, the material is ground by impacts between the grinding balls, the vessel and the material to be ground.

Ball mill according to step b) as described above can be carried out using a planetary mill or a centrifugal mill.

According to another aspect, the present disclosure also relates to the use of a glass as defined above or of a powder as defined above for making an electrode, in particular a positive electrode, in particular for a metal-ion accumulator.

All the embodiments previously described in relation to glass and/or glass particles, and/or a powder of the present disclosure also apply here, alone or in combination.

According to another aspect, the present disclosure also relates to the use of a glass or a glass powder for producing an electrode, in particular a positive electrode, in particular for a metal-ion battery or accumulator, the glass being of the following formula (I₀):

All the embodiments previously described in relation to glass and/or glass particles, and/or a powder of the present disclosure also apply here, alone or in combination.

According to another aspect, the present disclosure also relates to the use of a glass or a glass powder for producing an electrode, in particular a positive electrode, in particular for metal-ion battery or accumulator, the glass being of the following formula (I₀):

$$x L {i}_{2} O \cdot y N i O \cdot ( 100 - x - y ) {P}_{2} {O}_{5} , \qquad ( {I}_{0} )$$

with:

0<x<100,

$$10 \leq y < 100 , and$$

$$x + y < 100 .$$

All the embodiments previously described in relation to glass and/or glass particles, and/or a powder of the present disclosure also apply here, alone or in combination.

According to another aspect, the present disclosure also relates to an electrode, in particular a positive electrode, in particular for metal-ion battery or accumulator, comprising a glass as defined above or a powder as defined above.

All the embodiments previously described in relation to glass and/or glass particles, and/or a powder of the present disclosure also apply here, alone or in combination.

According to another aspect, the present disclosure also relates to an electrode, in particular a positive electrode, in particular for metal-ion battery or accumulator, comprising a glass or a glass powder, the glass having the following formula (I₀):

$$x L {i}_{2} O \cdot y N i O \cdot ( 100 - x - y ) {P}_{2} {O}_{5} , \qquad ( {I}_{0} )$$

with:

0<x<100,

$$10 \leq y < 100 , and$$

$$x + y < 100 .$$

Some of, or all of, the embodiments previously described in relation to glass and/or glass particles, and/or a powder of the present disclosure also apply here, alone or in combination.

According to another aspect, the present disclosure also relates to a method for preparing an electrode, in particular a positive electrode, in particular for metal-ion battery or accumulator, said method comprising a step A) of bringing a powder consisting of or comprising glass particles, an electronically conductive additive, in particular carbon particles, and optionally a binder, as defined above, into contact with a conductive support.

Some of, or all of, the embodiments previously described in relation to glass and/or glass particles, and/or a powder of the present disclosure also apply here, alone or in combination.

According to a particular embodiment, the conductive support is a metal support, the metal being aluminum (Al) and copper (Cu).

According to a particular embodiment, the method of the present disclosure as defined above comprises:
A₀) a step of preparing an ink by adding a solvent, in particular chosen from N-methyl-2-pyrrolidone (NMP), or aqueous-based polymers (such as carboxymethylbatteryulose, for example), to a powder consisting of or comprising glass particles, an electronically conductive additive, in particular carbon particles, and optionally a binder, the binder being, for example, previously dissolved in a solvent, in particular N-methyl-2-pyrrolidone (NMP), as defined above, and, optionally, homogenization, in particular by mechanical agitation, in order to obtain a suspension;
A) a step A) of bringing a suspension as obtained at the end of step A) into contact with a conductive support, in particular by coating, for example of the “doctor blade” type, in order to obtain a device;
B) optionally, a step of drying said device;
C) optionally, a step of shaping, in particular by pelletizing, said device, possibly dried, in particular at a temperature of between 50 and 100° C., in particular at about 60° C., and/or for 1 to 48 hours, for example for about 24 hours.

According to another aspect, the present disclosure also relates to a battery or accumulator comprising an electrode, in particular a positive electrode, comprising a glass as defined above or a powder as defined above.

Some of, or all of, the embodiments previously described in relation to glass and/or glass particles, and/or a powder of the present disclosure also apply here, alone or in combination.

According to another aspect, the present disclosure also relates to a battery or accumulator comprising an electrode, in particular a positive electrode, comprising a glass or a glass powder, the glass being of the following formula (I₀):

$$x L {i}_{2} O \cdot y N i O \cdot ( 100 - x - y ) {P}_{2} {O}_{5} , \qquad ( {I}_{0} )$$

with:

0<x<100,

$$10 \leq y < 100 , and$$

$$x + y < 100 .$$

Some of, or all of, the embodiments previously described in relation to glass and/or glass particles, and/or a powder of the present disclosure also apply here, alone or in combination.

According to a particular embodiment, the battery or accumulator as defined above also comprises at least one electrolyte, a separator, in particular a microporous separator, and a negative electrode, in particular consisting of or comprising a metal chosen from Li, Na and K.

These components are well known to the person skilled in the art, who will be able to select them, in particular off the shelf, as required.

The negative electrode can also be made of or include hard carbon or graphite.

According to a particular embodiment, the battery or accumulator as defined above has a theoretical specific capacity greater than 80 mAh/g, in particular greater than 100 or even 120 mAh/g, and for example up to or exceeding 140 mAh/g.

The batteries and accumulators of the present disclosure can, for example, be used in the field of electrical storage, in particular stationary, or in electrical mobility, in particular for portable or placeable electronics, for integration into fibers and/or cables, in particular in the context of wired battery packs, or for medical use.

In particular, the batteries and accumulators of the present disclosure can be used in the field of electric mobility, in particular for electric vehicles, rechargeable hybrid electric vehicles, hybrid vehicles or electric 2-wheelers.

In particular, the batteries and accumulators of the present disclosure can be used in the field of portable electrical equipment, in particular telephones, portable computers or portable tools.

According to another aspect, the present disclosure also relates to a battery pack comprising a battery or accumulator as defined above.

Some of, or all of, the embodiments previously described in relation to glass and/or glass particles, and/or a powder of the present disclosure, and/or an electrode, and/or a battery or accumulator also apply here, alone or in combination.

According to another aspect, the present disclosure also relates to an electroportable system or a system adapted to electric mobility, comprising a battery pack as defined above.

Some of, or all of, the embodiments previously described in relation to glass and/or glass particles, and/or a powder of the present disclosure, and/or an electrode, and/or a battery or accumulator also apply here, alone or in combination.

### Definitions

As understood here, value ranges in the form of “x-y” or “from x to y” or “between x and y” include the limits x and y, the integers between these limits, and all other real numbers between these limits. By way of example, “1-5”, or “from 1 to 5” or “between 1 and 5” designate the integers 1, 2, 3, 4 and 5, as well as all the other real numbers between 1 and 5. Preferred embodiments include each individual integer within the value range, as well as any sub-combination of these integers and any set of real numbers between these integers. For example, preferred values for “1-5” may comprise the integers 1, 2, 3, 4, 5, 1-2, 1-3, 1-4, 1-5, 2-3, 2-4, 2-5, etc.

As used in this description, the term “about” refers to a range of values ±10% of a specific value. By way of example, the expression “about 20” comprises the values 20±10%, i.e. the values 18 to 22.

For the purposes of this description, percentages refer to percentages by mass in relation to the total mass of the formulation, unless otherwise stated.

### EXAMPLES

### Example 1: Preparation of glass 31 LizO·15 NiO·54 P₂O₅

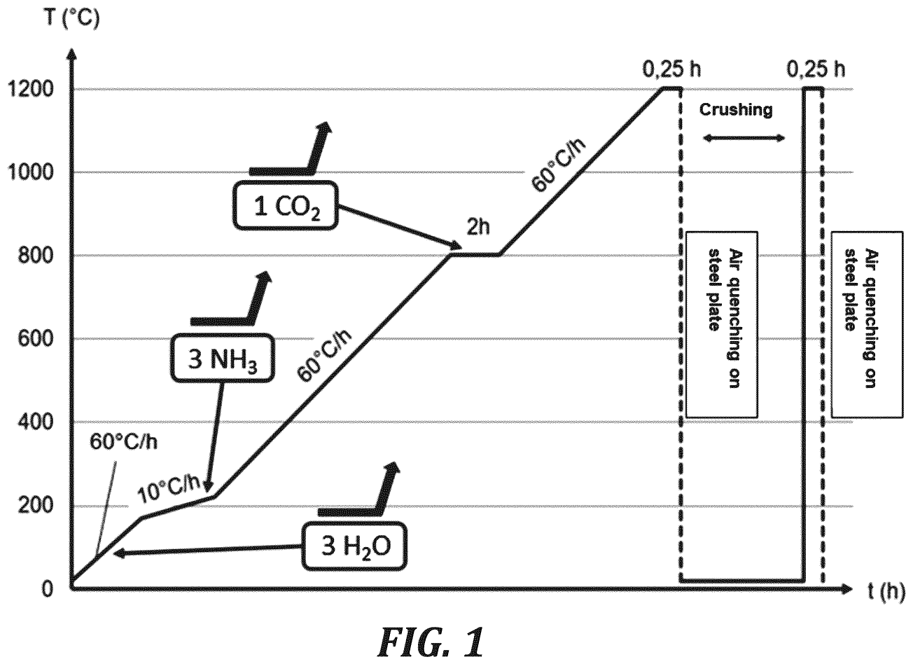

The glass in the 31 Li₂O·15 NiO·54 P₂O₅ system was produced by air quenching on a stainless steel plate from a cast iron bath refined at 1200° C. for 15 minutes, as shown in FIG. 1. This intermediate crushing may make it possible, if necessary, to homogenize the molten liquid. The target molar proportion is obtained by weighing the different precursor powders ((NH₄)₂HPO₄ for P₂O₅, Li₂CO₃ for Li₂O, NiO for NiO) making up the mixture. These precursors are then placed in Rhodium Platinum crucibles to avoid diffusion of parasitic elements as in the case of alumina crucibles (diffusion of aluminum).

The cast iron bath is obtained by subjecting the mixture of precursor powders to a specific heat treatment (FIG. 1) to eliminate the chemical species from the precursors (CO₂, H₂O and NH₃), in particular between 150° C. and 220° C. for the moles of NH₃ and at 800° C. for 2 h for the moles of CO₂.

The reaction equations are as follows:

$${( N {H}_{4} )}_{2} H P {O}_{4 ( s )} ⇌ N {H}_{4} {H}_{2} P {O}_{4 ( s )} + N {H}_{3 ( g )}$$

$$L {i}_{2} C {O}_{3} + 2 ( N {H}_{4} {H}_{2} P {O}_{4} ) + N i O ⇌ [ C {O}_{2 ( g )} + 2 N {H}_{3 ( g )} + 3 {H}_{2} {O}_{( g )} ] + L {i}_{2} O + {P}_{2} {O}_{5} + N i O$$

The raw material (without any subsequent heat treatment such as stabilization annealing) is then analyzed to determine its actual chemical composition, its amorphous nature and its microstructural and elemental homogeneity.

Initially, analyses by Inductively Coupled Plasma Atomic Emission Spectroscopy (ICP-AES) and measurements by Energy Dispersive X-ray Spectroscopy (EDX) enabled to determine the actual composition of the sample.

The amorphous nature of the material was verified and confirmed by X-ray powder diffraction.

Initially, the microstructural homogeneity of the glass was confirmed using Scanning Electron Microscopy (SEM) by acquiring backscattered electron images from a polished section of the raw material. Coupled with an Energy Dispersive X-ray Spectroscopy (EDX) detector, it was possible to carry out pointing to quantify the elements present in the sample, confirming the chemical composition.

Elemental distribution mappings were then obtained to thus verify and confirm the homogeneity of elemental distribution within the sample.

The glass was then ground for 3 minutes at 30 Hz using a vibratory mill (Retsch MM400) to form a button battery for electrochemical analysis.

### Example 2: Electrochemical Characterization of the Lithiated Glasses of the Present Disclosure

### Preparing the Electrodes

Initially, an intimate mixture of active material/black carbon (super carbon C65) in the mass proportions 70/25 was prepared using an energy mill (PM100 planetary mill) in the dry method. The grinding protocol lasted a total of 6 hours at 300 rpm, alternating 5 minutes of grinding with 5 minutes of rest (in order to avoid local heating that could lead to potential devitrification/crystallization), i.e. 3 hours of actual grinding. The ground powder was then characterized by X-ray diffraction to ensure that the amorphous nature of the glass/carbon mixture was maintained.

The glass/carbon powder (i.e. composite material) obtained is then mixed with 5% by weight of polymer binder (solution of 10% by weight of Polyvinylidene Fluoride (PVDF) diluted in N-Methyl-2-Pyrrolidone (NMP)). Additional solvent (NMP) is then added to obtain an ink of acceptable viscosity for coating. This ink, consisting of a dispersion of composite particles in PVDF and NMP, is mechanically agitated (for 15 minutes at 1000 rotations per minute) using a mechanical disperser (Dispermat). This is used to homogenize the dispersion and disperse the composite aggregates formed during the grinding stage. The ink is then coated using the doctor blade method (coating table with a slit doctor blade set at 100 μm) on an aluminum sheet, then dried for 24 hours at 60° C. in air to eliminate the residual solvent (NMP).

After drying, the resulting electrode was cut into discs 14 mm in diameter, which were then pressed under a pressure of 10 tons. The mass and thickness of the pellets were measured. The pellets were then dried under vacuum for 48 hours at 80° C. to remove any residual water. Finally, the electrodes were transferred to a glove box ([H₂O]<3 ppm, [O₂]<1 ppm), to be mounted in button batteries.

### Button Batteries Production

The electrodes are mounted in a so-called half-button battery configuration (CR2032 type format), in a glove box, in a Li-metal or Na-metal or K-metal configuration. The electrodes are placed in a cover, inside which an insulating gasket is affixed. Two separators are added to the electrode to be tested: a Viledon felt used as an electrolyte reservoir, and a Celgard microporous separator to prevent sodium dendritic growth. In the case of a K-ion battery, a single separator, the Whatmann, was used. A volume of 150 μL of electrolyte is added to the propipette. The counter-electrode, a sheet of metal (Li, Na or K) deposited on a stainless-steel wedge, is then placed on top of the separators. A spring is added to the counter-electrode, then the half button battery is closed with a small lid and crimped.

Depending on the configuration, the three electrolytes used are as follows:
Li-metal: 1M LiPF₆ in EC: DMC: EMC (1:1:1 vol.)
Na-metal: 1M NaPF₆ in EC: DMC (50% vol.: 50% vol.)+2%ₘₐₛₛ. of FEC
K-metal: 0.7M KPF₆ in EC: DEC (50% vol.: 50% vol.)+2%ₘₐₛₛ. of VC

### Galvanostatic Cycling

The performance of the resulting battery is evaluated using an ARBIN-type test bench. The batteries are typically cycled at C/100, at room temperature, with a potential window between 1.5V and 4.5V. Cycling tests are then initiated either in charge configuration (extraction of lithium from the glass structure) or in discharge configuration (insertion of lithium into the glass structure).

### Examples of Galvanic Cycling Curves

As the glass contains lithium, the accumulator is initially placed in charge configuration in order to extract the lithium from the glass structure.

A galvanostatic cycling test with a load start with a terminal at 4.5 V potential vs Li⁺/Li.

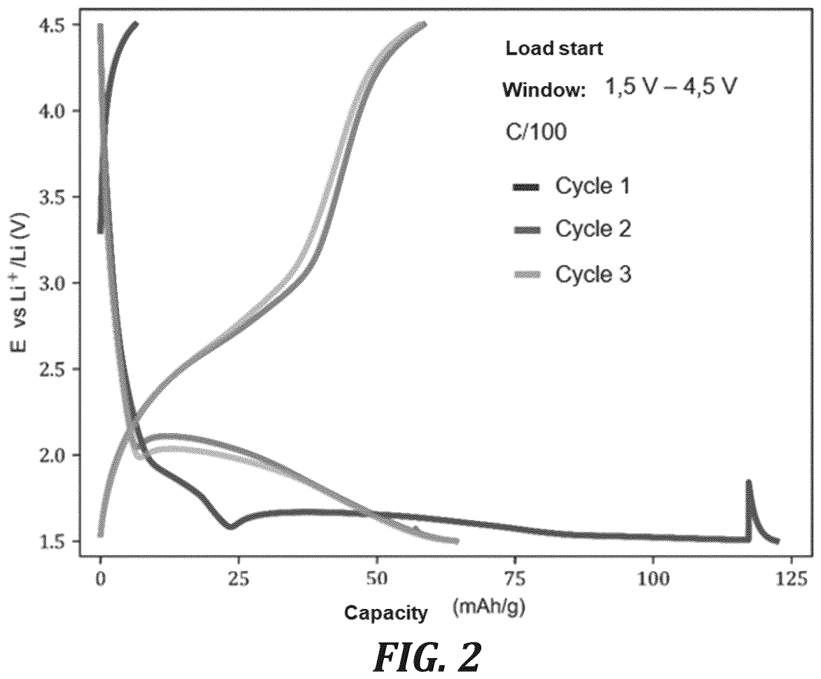

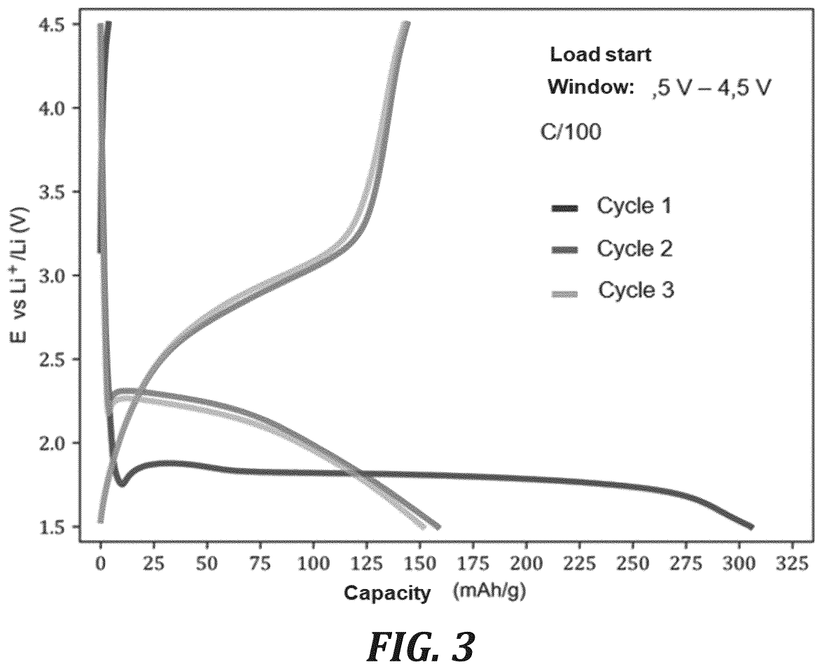

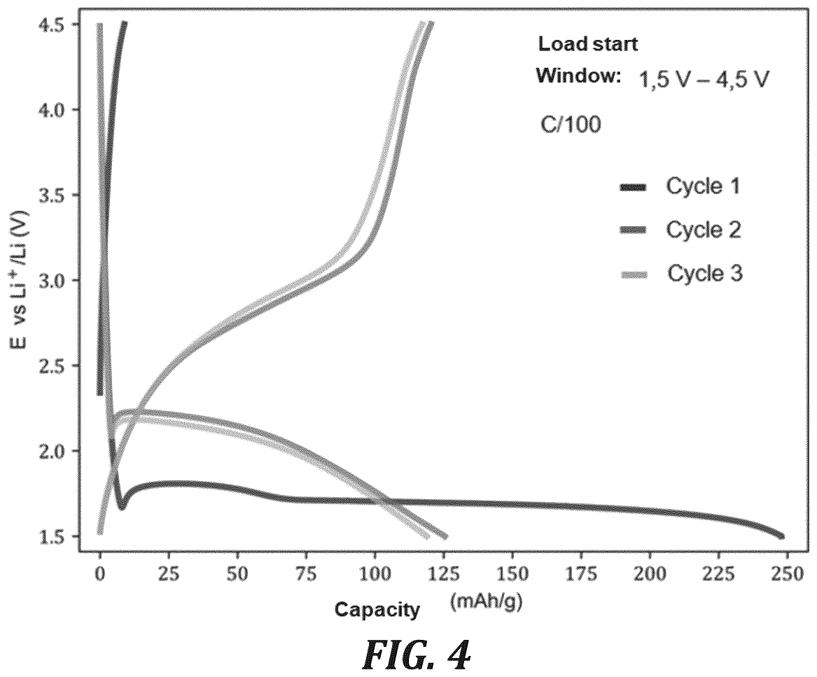

FIGS. 2 to 4 show examples of galvanic cycling curves.

The detailed description set forth above in connection with the appended drawings, where like numerals reference like elements, are intended as a description of various embodiments of the present disclosure and are not intended to represent the only embodiments. Each embodiment described in this disclosure is provided as a representative example or illustration and should not be construed as preferred or advantageous over other embodiments. The representative examples provided herein are not intended to be exhaustive or to limit the disclosure to the precise forms disclosed. Similarly, any steps described herein may be interchangeable with other steps, or combinations of steps, in order to achieve the same or substantially similar result. Generally, the embodiments disclosed herein are non-limiting, and the inventors contemplate that other embodiments within the scope of this disclosure may include structures and functionalities from more than one specific embodiment shown in the figures and described in the specification. That is, the present disclosure includes embodiments that combine features from different embodiments.

In the foregoing description, specific details are set forth to provide a thorough understanding of exemplary embodiments of the present disclosure. It will be apparent to one skilled in the art, however, that the embodiments disclosed herein may be practiced without embodying all the specific details. In some instances, well-known process steps have not been described in detail in order not to unnecessarily obscure various aspects of the present disclosure. Further, it will be appreciated that embodiments of the present disclosure may employ any combination of features described herein.

In the detailed description herein, references to “one embodiment”, “an embodiment”, “an example embodiment”, “one or more embodiments,” “particular embodiment,” etc., indicate that the embodiment described may include a particular feature, structure, or characteristic, but every embodiment may not necessarily include the particular feature, structure, or characteristic. Moreover, such phrases are not necessarily referring to the same embodiment. In addition, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments. Thus, it will be appreciated that embodiments of the present disclosure may employ any combination of features described herein. All such combinations or sub-combinations of features are within the scope of the present disclosure.

Throughout this specification, terms of art may be used. These terms are to take on their ordinary meaning in the art from which they come, unless specifically defined herein or the context of their use would clearly suggest otherwise.

The drawings in the FIGURES are not to scale. Similar elements are generally denoted by similar references in the FIGURES. For the purposes of this disclosure, the same or similar elements may bear the same references. Furthermore, the presence of reference numbers or letters in the drawings cannot be considered limiting, even when such numbers or letters are indicated in the claims.

In the claims and for purposes of the present disclosure, the terms “a”, “an”, “the”, and the like, refer to the singular and the plural forms of the object or element referenced.

The principles, representative embodiments, and modes of operation of the present disclosure have been described in the foregoing description. However, aspects of the present disclosure, which are intended to be protected, are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure as claimed.

1. A glass of the following formula (I):
$$x L {i}_{2} O \cdot y N i O \cdot ( 100 - x - y ) {P}_{2} {O}_{5} , \qquad ( I )$$
wherein:
0<x<100,
$$10 \leq y < 100 , and$$
$$40 < x + y < 100 .$$

2. The glass of claim 1, wherein 41<x+y<100, 42<x+y<100, 43<x+y<100, 44<x+y<100, or 45<x+y<100.

3. A method for preparing a glass according to claim 1, comprising a step (i) of quenching a molten mixture (A), wherein (A) comprises a source of NiO, a source of Li₂O and a source of P₂O₅.

4. The method of claim 3, wherein step (i) produces an intermediate glass, the method further comprising:
a step (ii) of crushing the intermediate glass obtained at the end of step (i);
a step (iii) of quenching the crushed intermediate glass obtained at the end of step (ii), previously in a molten state, to obtain the glass according to claim 1.

5. The method of claim 3, wherein:
the source of NiO comprises NiO, Ni₂O₃, NiSO₄, or a combination thereof;
the source of Li₂O comprises Li₂CO₃, Li₂SO₄, LiOH, or a combination thereof; and
the source of P₂O₅ comprises NH₄H₂PO₄, P₂O₅, (NaPO₃)₆, H₃PO₄, (NH₄)₂HPO₄, or a combination thereof.

6. A powder comprising particles of the glass of claim 1, wherein the particles have a size between 0.1 and 100 μm.

7. The powder of claim 6, further comprising an electronically conductive additive, wherein the electronically conductive additive is carbon particles.

8. An electrode comprising a glass according to claim 1.

9. A method for preparing an electrode, said method comprising a step A) of bringing a powder comprising the glass particles of claim 6, and an electronically conductive additive comprising carbon particles and a binder, into contact with a conductive support comprising a positive electrode.

10. A battery or accumulator comprising an electrode, the electrode comprising a positive electrode, the electrode further comprising a glass according to claim 1, wherein the glass comprises a theoretical capacity greater than 80 mAh/g.

11. A battery pack comprising a battery or accumulator according to claim 10.

12. An electroportable system comprising a battery pack according to claim 11.

13. The glass of claim 1, wherein formula (I) is 31 Li₂O·15 NiO·54 P₂O₅, 14 Li₂O·28 NiO·58 P₂O₅, or 21.5 Li₂O·21.5 NiO·57 P₂O₅.

14. The glass of claim 2, wherein 0.5<x/y<2.5, 0.5<x/y<3.0, or 0.5<x/y<4.0.

15. The method of claim 4, wherein step (i) is preceded by a step of agitation of the mixture (A).

16. The powder of claim 6, wherein the size of the particles is between 0.1 and 50 μm.

17. The powder of claim 7, wherein the electronically conductive additive further comprises a binder.

18. The electrode of claim 8, wherein the electrode is a positive electrode, and wherein the positive electrode is configured for a metal-ion battery or accumulator.

19. The method of claim 9, wherein the electrode comprises a positive electrode for a metal-ion battery or accumulator.

20. A system adapted for electric mobility comprising a battery pack according to claim 11.
